(19) United States
(12) Patent Application Publication
(10) Pub. No.: US 2002/0100754 A1
(43) Pub. Date: Aug. 1, 2002

(54) Process and device for heating printed material or toner

(76) Inventors: Knut Behnke, Kiel (DE); Hans-Otto Krause, Eckernforde (DE); Frank-Michael Morgenweck, Molfsee (DE); Domingo Rohde, Kiel (DE); Detlef Schulze-Hagenest, Molfsee (DE); Gerhard Bartscher, Koln (DE); Kai-Uwe Preissig, Dortmund (DE); Dinesh Tyagi, Fairport, NY (US)

Correspondence Address: Lawrence P. Kessler, Patent Department, NexPress Solutions LLC, 1447 St. Paul Street, Rochester, NY, 14653-7103, US

(21) Appl. No.: 10/011,624

(22) Filed: Dec. 4, 2001

(30) Foreign Application Priority Data
Dec. 22, 2000 (DE) 100 64 565.8
Sep. 12, 2001 (DE) 101 45 004.4

(51) Int. Cl. H05B 6/80

(52) U.S. Cl. 219/679; 399/336

(57) ABSTRACT

A device and process for fixing a toner onto a substrate or a printed material, especially a sheet-shaped printed material, preferably for a digital printer, which is characterized in that the printed material that has the toner is irradiated with microwaves from at least one microwave emitter and is heated to melt the toner and that a toner is used which exhibits a sharp drop of the modulus of elasticity G′ from its solid to its liquid state when it is heated. Preferably, the ratio of the value of the modulus of elasticity G′ of the toner according to the invention at the reference temperature value, calculated from the starting temperature at the beginning of the glass transformation of the toner plus 50° C., to the value of the modulus of elasticity G′ at the starting temperature itself is <10⁻⁵.

### FIELD OF THE INVENTION

The invention involves a process and device for heating printed material or toner, especially for fixing toner onto a substrate or a printed material, especially a sheet-shaped or a band-shaped printed material, preferably for a digital printer.

### BACKGROUND OF THE INVENTION

In digital printing, especially electrostatic or electrophotographic printing, a latent electrostatic image is generated, which is developed by charged toner particles. These toner particles are transferred onto a printed material, e.g. paper, that receives the image. The image transferred onto the printed material is fixed there by heating and softening of the toner or heating of the printed material. Through and during this process, toner particles bond to the printed material and, possibly, also to each other.

For the fixing of the toner onto the printed material, the use of microwaves is known. Since the absorption of microwave energy in the toner customarily is at least one order of magnitude less than in the printed material, the printed material is preferably heated up by the microwaves and the printed material for its part heats up the toner located on it, and, to be precise, up to a temperature, at which the toner bonds to the printed material. As is known, characteristic values of the printed material used, such as, for example, weight, humidity, and composition, are critical in the use of microwaves for fixing of the toner and must be taken into consideration.

Thus, for example, an image-fixing device is known from U.S. Pat. No. 4,511,778, which fixes an image made of toner using high-frequency waves, in particular, microwaves, onto a printed material, especially a sheet of paper. One aspect of the known device is thus the possibility to output the microwaves depending on the size of the printed material, in order to ensure a proper fusing and fixing of the toner taking into account this size as a characteristic value of the printed material. This is a method that is rather all-inclusive and only takes into consideration a size of the printed material that is directly apparent and specifies for the operation of the device, prior to fixing, based on consideration for example, that a larger piece to be heated requires more energy in total than a smaller piece to be heated, because of its larger heat capacity.

However, additional critical aspects remain unconsidered in the use of microwaves for the fixing of toner. Thus, for example, the cited method can only be used in black-white printing with paper weights of a small variation width, while the possibly different behavior of different colored toner and different paper weights, also with possibly different water content, is not considered in this all-inclusive method that is matched to the size of the printed material. In a color print, the toner image can, for example, have four different toner layers. In the process, the maximum density of each toner layer on the image-receiving substrate or printed material is 100%, whereby a maximum total density of the toner layers in the toner image of 400% results. Customarily, the density of a single-color toner image is in the range from 0% to 100% density, and the density of a color toner image is in the range from 0% to 290%.

In addition, during the use of sheet-shaped printed material, a problem can occur that in the area of the edge area of the sheet irradiated with microwaves, processing is done in an energetically different way than the middle sheet area, so that a non-uniformly created printed product can occur. In addition, it occurs that during the fixing of traditional toners, only when using microwaves under certain circumstances, only an incomplete melting of the toner is obtained depending on its layer thickness, or heating occurs with bubble formation in areas of the toner. Also, the adhesion of the toner onto the printed material is insufficient under certain circumstances, because, for example, the bond with the printed material is not created sufficiently by the viscosity of the melted toner, which is too high. Problems can occur especially when a printed material is printed on both sides in two subsequently performed printing operations.

Because of these possible problems depicted, the use of microwave radiation in fixing is traditionally and customarily not relied upon, but instead, the toner is in practice heated without microwave radiation and bonded to the printed material using a heated pair of rollers while being impinged with pressure. A non-contact fixing is in principal, however, desirable for the protection of the printed image. Additional advantages of the non-contact fixing are the avoidance of adhesive abrasion and the resultant increased service lifetime of the device used, and an improved reliability of the device.

### SUMMARY OF THE INVENTION

The purpose of this invention is to make possible an adequate fixing of toner onto a printed material or its preparation by using microwaves, preferably also for a multicolor printing on sheet-shaped printed material and preferably by adjusting to the special prevalent conditions. This purpose is achieved according to the invention in regard to the process in that the printed material that has the toner is irradiated with microwaves from at least one microwave emitter and is heated to melt the toner and that a toner is used which has a sharp transition from its solid to its liquid state during heating.

In this way according to the invention, for example, a dry toner can be used which is still quite hard at an average temperature of approximately 50° C. to 70° C., so that it can be powdered via conventional processes into a desired average toner size of, for example, 8-4 micrometers and also does not yet become sticky or does not melt at development temperatures, but at a higher temperature of, for example, approximately 90° C. is already very fluid at low viscosity, so that it, if necessary in using capillarities, also without outside pressure and in a non-contact manner settles on and in the printed material and adheres, and upon a cooling down then becomes hard again very quickly and is fixed. To be precise, the fused toner has a good surface gloss that is matched to the printed material, especially lacking formed grain boundaries. The surface gloss also plays a direct, meaningful role for color saturation in colored toner.

In this process, in connection with the toner according to the invention, the ratio of the value of the modulus of elasticity G′ at the reference temperature value, calculated from the starting temperature at the beginning of the glass transformation of the toner plus 50° C., to the value of the modulus of elasticity at the starting temperature itself can be <1E-5, preferably even <1E-7, whereby E represents the base 10 exponent. The starting temperature of the beginning of the glass transformation of the toner is preferably specified as that temperature value at which the tangents to the function progression of the modulus of elasticity G′, depending on the temperature before and after the glass transformation, intersect. Preferably, the transformation of the toner from its solid into its liquid state should occur in a temperature interval or temperature window from approximately 30° to 50° C. in size. This range should be above 60° C., preferably approximately between 70° C. to 130° C., quite preferably between 75° C. and 125° C.

An additional further embodiment of the process according to the invention is characterized for adjusting to the special conditions in that at least one physical process parameter is controlled or regulated depending on a parameter that correlates to the energy input into the printed material that has the toner. According to the invention, a simple all-inclusive specification is thus not provided, but instead a regulation is advantageously provided that is adjusted to the actual, preferably measured relationships. In this process, the energy input mentioned can essentially correspond to a microwave power that has been absorbed by the entire system out of printed material and toner, so that, according to the invention, corresponding to the actual relationships, the energy that has been output is compared to the absorbed power and tuned. This in turn corresponds essentially to an efficiency control or adjustment. In the process, the performance of a regulation on the emitter in the most general sense, which also can be identified as a microwave source, or on the absorbing toner-printed material system or on its handling is generally taken into consideration.

For this purpose, the invention preferably proposes in detail to regulate the output of the microwave emitter or to regulate the speed of the movement of the printed material or to adjust the frequency of the microwaves, and this last measure preferably also in order to achieve a higher energy absorption directly in the toner itself, and in this way to have a more precise influence on its fusing than indirectly and more problematically, via the printed material. As measurable parameters for the dependent regulation, the invention preferably proposes the temperature of the printed material or the microwave energy reflected by the toner-printed material system and thus not absorbed. Additional measurable parameters can—without limitation of them—be the weight/the thickness or the water content of the printed material or density and gloss of the toner layer.

In principal, all frequencies of the microwave range from 100 MHz to 100 GHz can be used. Usually, the ISM-frequencies released for industrial, scientific or medicinal use, preferably, 2.45 GHz, are used. A use of other frequencies in the wide frequency range mentioned can, however, advantageously lead to a larger portion of the radiation energy being absorbed by the toner than is customary, so that it is not just absorbed by the printed material. A device which is characterized as an independent solution to the purpose of the invention in that for the irradiation and heating of the toner that exhibits a sharp transformation from its solid to its liquid state when heated, at least one emitter that outputs microwaves is provided. Preferably one or more operating parameters are additionally provided that can be regulated.

An additional embodiment of the device according to the invention is characterized by at least one microwave guide in the form of a closed ring or a closed loop. The structure of the microwave guide according to the invention has the advantage of a uniform and homogenous heating of the printed material. This is accompanied especially by a field strength of the electric field that is for the most part constant at a high efficiency and by a compact structural shape. The ring shape can be made even more compact in that straight partial pieces, which run crosswise to the transport direction of the printed material, are pushed tightly against each other. In addition, the microwave guide width can be possibly reduced for a corresponding increase of the field strength. A compact structural shape is especially desirable when printing the printed material while working with sheets and for fixing of the respective toner image required for this type of operation. Depending on the microwave energy that is supplied, the field strength should be 3 kV/mm at maximum, and preferably approximately 0.2 kV/mm up to approximately 1.0 kV/mm.

In the ring-shaped microwave guide according to the invention, microwave energy is supplied into the microwave guide in a suitable manner. The microwave is guided in the closed loop of the ring. When the microwave passes through the closed loop, the printed material that may be carrying the toner is heated in the heating area. The microwave runs through the closed loop periodically in the same direction until the microwave energy has been absorbed by the printed material or the toner. A small part of the microwave energy is converted into heat as dissipated energy in the inner walls of the microwave guide. The design of a microwave guide according to the invention is especially suitable for materials with a relatively low absorption.

The device according to the invention is not only itself suitable as a fixing device or fuser, but instead it could also be used advantageously as a pre-heating device for a subsequent fixing device. It would also be suitable as a conditioning device for the conditioning of printed material, especially paper. A change of the printed material can then be done readily by heat impingement prior to the beginning of the printing process.

The device according to the invention is preferably provided for a digital multi-color printer, so that protection is also claimed in the context of the invention for a printer equipped in this way.

### BRIEF DESCRIPTION OF THE DRAWINGS

Exemplary explanations of the invention are made in the following in relation to 4 figures, from which additional inventive measures result without the invention being restricted to the examples or figures that are explained.

Shown are:

FIG. 1 which represents the functional progression of the modulus of elasticity G′ of a toner depending on the temperature, for the definition of the starting temperature of the glass transformation of the toner;

FIG. 2 which represents the measured functional progressions according to FIG. 1 of a toner according to the invention and two toners according to the state of the art for purposes of comparison;

FIG. 3 which is a schematic overhead view of a microwave guide according to the invention; and

FIG. 4 which is a side view of the microwave guide according to FIG. 3.

### DETAILED DESCRIPTION OF THE INVENTION

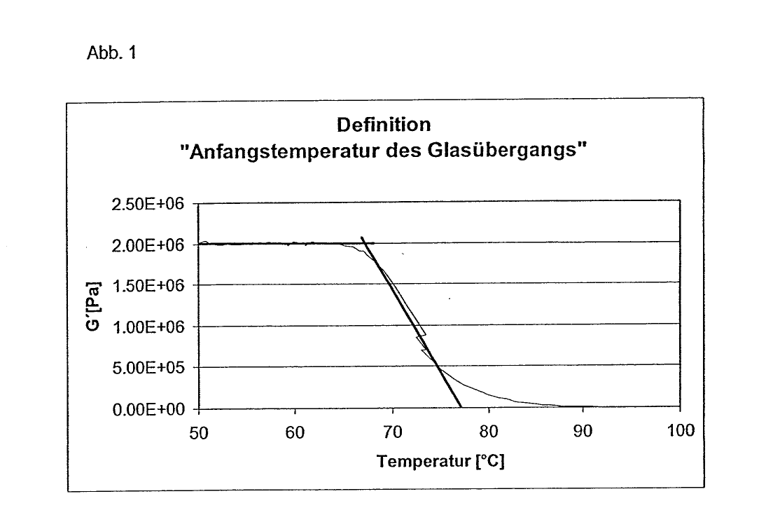

The G′-ratio is the ratio of the modulus of elasticity G′ at the starting temperature of the glass transformation plus 50° C. to G′ at the starting temperature of the glass transformation. The starting temperature of the glass transformation is determined according to FIG. 1 from the intersection point of the tangents at G′ prior to and after the glass transformation and is at just under 70° C. in the example shown.

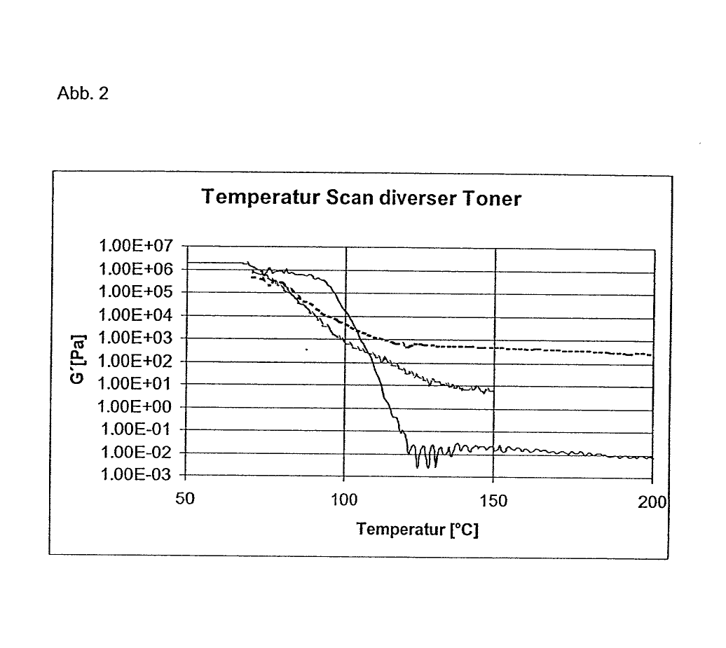

In FIG. 2, the measured functional progression of G′ according to FIG. 1 is shown for three exemplary toners. The functional values of G′ were determined by a rheological measurement in a Bolin-rheometer, equipped with parallel plates of 40 mm diameter. A continuous temperature change at a frequency of 1 rad/s corresponding to 0.16 Hz was performed between 50° C. and 200° C. The strain of the measurement was selected such that the sample shows no shear thinning (Newton's behavior). Only the toner according to the invention shows a sharp transformation from solid to liquid state with a final G′ value of approximately 1.00E-02. From this, a G′ ratio of 5.0E-08 results.

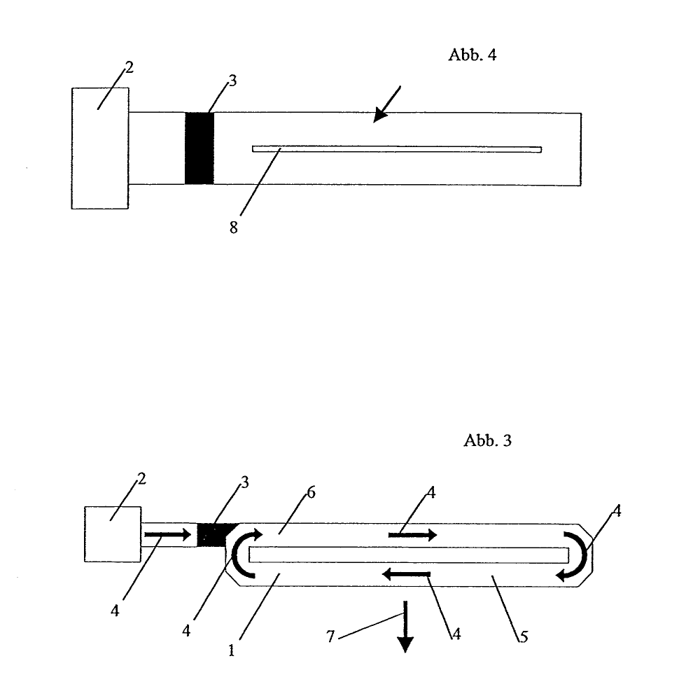

FIG. 3 shows schematically, in an overhead view, a microwave guide 1 in the form of a closed ring, which is connected to a system 2 for generating microwaves via a system 3 for coupling microwaves, and through which the microwaves progress in the direction of the arrows 4. The ring shape has straight partial pieces 5, 6 that are parallel to each other, which extend crosswise to a transport direction 7 for a printed material (not shown in greater detail) and follow one another in a relatively compact and close manner.

FIG. 4 shows a side view of the arrangement according to FIG. 3. Equivalent structural elements are indicated with equivalent reference indicators as in FIG. 3. In FIG. 4, a through-passage slot 8 for the printed material can be seen in the microwave guide 1.

The invention has been described in detail with particular reference to certain preferred embodiments thereof, but it will be understood that variations and modifications can be effected within the spirit and scope of the invention.

What is claimed is:

1. Process for fixing a toner onto a substrate or a printed material, especially a sheet-shaped printed material, preferably for a digital printer, characterized in that, the printed material that has the toner is irradiated with microwaves from at least one microwave emitter, and is heated to melt the toner, and that a toner is used which has a sharp drop of the modulus of elasticity G′ from its solid to its liquid state when it is heated.

2. Process according to claim 1, characterized in that, the ratio of the value of the modulus of elasticity G′ at the reference temperature value, calculated from the starting temperature at the beginning of the glass transformation of the toner plus 50° C., to the value of the modulus of elasticity at the starting temperature is <10⁻⁵, preferably <10⁻⁷.

3. Process according to claim 2, characterized in that, the transformation of the toner from its solid to its liquid state occurs in a temperature interval of approximately 50° C. or less.

4. Process according to claim 3, characterized in that, the aforementioned temperature interval of the state change of the toner extends above 60° C., preferably in the range from approximately 75° C. to approximately 125° C.

5. Process for fixing a toner according to claim 2, characterized in that at least one physical process parameter is controlled or regulated depending on a parameter that correlates to the energy input into the printed material that has the toner.

6. Process according to claim 5, characterized in that the output of the microwave emitter is regulated depending on the energy input, in such a manner that at too low an energy input, the output is increased and at too high an energy input, the output is reduced, in order to obtain on average an essentially constant, proper energy input.

7. Process according to claim 5, characterized in that the speed of the movement of the printed material through an area irradiated with microwaves is regulated depending on the energy input in such a manner that at too low an energy input, the printed material is fixed at a lower speed, and at too high an energy input, the printed material is fixed at a higher speed.

8. Process according to claim 5, characterized in that the microwave emitter is tuned depending on the energy input or is tuned with regard to the frequency of the microwaves emitted by it.

9. Process according to claim 5, characterized in that the temperature of the printed material is taken as a parameter correlating to the energy input.

10. Process according to claim 5, characterized in that the efficiency of the energy input is taken as a parameter correlating to the energy input.

11. Process according to claim 10, characterized in that the reflected output or energy of the resonator that contains a printed material partially or completely is measured as a parameter correlating to the energy input and is compared to the output released by the microwave emitter or set into a ratio with it.

12. Process according to claim 2, characterized in that a frequency is selected of the released ISM-frequencies in a microwave frequency range from 100 MHz to 100 GHz, at which the portion of the absorption of microwave energy by the toner measured on the total absorption is selected to favor a higher absorption of the toner.

13. Process according to claim 2, characterized in that a color toner is used.

14. Device for heating printed materials or toners, especially for fixing toner onto a substrate or a printed material, especially a sheet-shaped printed material, preferably for a digital printer, characterized in that for the irradiation and heating of the toner, which exhibits a sharp drop of the modulus of elasticity G′ from its solid to its liquid state when it is heated, at least one emitter that emits microwaves is provided.

15. Device according to claim 14, characterized in that at least one physical operating parameter that influences the irradiation can be regulated depending on a parameter that correlates to the energy input into the toner-printed material arrangement.

16. Device for heating printed material or toner according to claim 15, characterized by a microwave guide in the shape of a closed ring or a closed loop.

17. Device according to claim 16, characterized in that said microwave guide, essentially running crosswise to a direction of transport of the printed material, has a flat shape.

18. Device according to claim 17, characterized in that said microwave guide has two straight partial pieces running parallel to each other and crosswise to the transport direction.

19. Device according to claim 18, characterized in that said straight partial pieces of said microwave guide are arranged adjacent to each other in a compact manner.

20. Device according to claim 16, characterized in that said microwave guide is provided for the preparation of an electric field strength of at maximum approximately 3 kV/mm, preferably from approximately 0.2 kV/mm up to approximately 1.0 kV/mm.

21. Device according to claim 14, characterized in that it is provided for a multi-color printer or is a component of such a multi-color printer, which operates according to an electrophotographic printing process.
